(19) United States
(12) Patent Application Publication
(10) Pub. No.: US 2008/0074794 A1
(43) Pub. Date: Mar. 27, 2008

(54) Method and apparatus for pitch angle actuation of slider based upon pressure and humidity conditions in a contact start-stop CSS

(75) Inventors: SungChang Lee, San Jose, CA (US); Brian D. Strom, Cupertion, CA (US)

Correspondence Address: GREGORY SMITH & ASSOCIATES, 3900 NEWPARK MALL ROAD, 3RD FLOOR, NEWARK, CA, 94560, US

(73) Assignee: Samsung Electronics Co., Ltd.

(21) Appl. No.: 11/525,681

(22) Filed: Sep. 22, 2006

(51) Int. Cl. G11B 5/48

(52) U.S. Cl. 360/245.3

(57) ABSTRACT

A pitch actuator coupling to at least the flexure finger of a head gimbal assembly, flexing the flexure finger to alter the pitch angle between slider and disk surface. Operating a head gimbal assembly by stimulating the pitch actuator to alter slider pitch angle and the head gimbal assembly implementing this method. Head stack assembly including at least one head gimbal assembly. CSS hard disk drive and embedded circuit controlling head stack assembly and its motion over disk surface. Manufacturing methods for head gimbal assembly, head stack assembly, embedded circuit and CSS hard disk drive and these items as products of these processes.

### TECHNICAL FIELD

This invention relates to the read-write head to disk interface in a CSS hard disk drive, in particular to active control of the pitch angle of the slider containing the read-write head to the rotating disk surface in a Contact Start-Stop CSS hard disk drive, particularly in response to the air pressure as associated with altitude and in response to humidity.

### BACKGROUND OF THE INVENTION

The Contact Start-Stop (CSS) CSS hard disk drive parks its slider on the disk surface near the inside diameter (ID) when not in operation. Doing this is economical, but engenders a number of other problems, which the inventors found themselves revisiting as they examined the particular effects of humidity on the CSS hard disk drive. Consequently, the discussion of the problem to be solved is found toward the beginning of the detailed description and the summary of the invention. Some terms should be mentioned here. Sliders in CSS hard disk drives tend to include at least one pad with diamond like Carbon on their air bearing surface. Stiction refers herein to static friction and is encountered when the CSS hard disk drive starts rotating the disks, between the parked slider and the disk surface it is parked on. These pads act as the contact regions between the slider and the disk surface and are used to reduce stiction. Tipping refers herein to the slider losing it orientation to the disk surface and when parked, no longer contacting the disk surface only through its pads.

### SUMMARY OF THE INVENTION

The inventors considered the effects of humidity, often in conjunction with pressure and/or temperature, with regards to the issues of tipping in a Contact Start-Stop (CSS) CSS hard disk drive. They have found methods and apparatus which can alter the pitch angle of the slider and may correct for these problems in certain situations.

The invention operates a head gimbal assembly in a CSS hard disk drive by asserting a pitch actuation control signal provided to at least one electrical coupling of a pitch actuator. The pitch actuator responding to the pitch actuation control signal by flexing the flexure finger toward the load beam to increase the pitch angle of the slider to a disk surface. The slider includes at least one Pad with Diamond Like Carbon (PDLC) on an air bearing surface for use in parking the slider on the disk surface in the CSS hard disk drive.

The invention's head gimbal assembly implements this method of operation, and includes a first coupling of the load bean to the flexure finger at a flexure coupling point, a second coupling of the load beam, the flexure finger and the slider at a dimple, and the pitch actuator coupling to the flexure finger between the flexure coupling point and the dimple. The flexure finger may include at least one pitch actuation control signal trace for providing the pitch actuation control signal to the pitch actuator.

The pitch actuator may include an electrostatic coupling responding to the pitch actuation control signal to urge the flexure finger toward the load beam to flex the flexure finger. The electrostatic coupling includes a first plate coupled to the flexure finger interacting with a second plate coupled to the load beam to attract the flexure finger to the load beam. The load beam may include the second plate. The flexure finger may include the first plate.

The pitch actuator may alternatively include a piezoelectric stack coupling to the flexure finger to urge the flexure finger toward the load beam to flex the flexure finger, when the piezoelectric stack is stimulated by the pitch actuation control signal.

The invention's head gimbal assembly may be manufactured by any of the following.
Coupling the pitch actuator and the slider to the flexure finger included in a head suspension assembly to create the head gimbal assembly, where the head suspension assembly further includes the flexure finger coupled at the flexure coupling point to the load beam.
Coupling an actuator mounted head suspension assembly to the slider to create the head gimbal assembly, where the actuator mounted head suspension assembly includes the pitch actuator coupled to the flexure finger included in the head suspension assembly.
Coupling the pitch actuator and a loaded micro-actuator assembly to the head suspension assembly to create the head gimbal assembly, where the loaded micro-actuator assembly includes a micro-actuator assembly coupled to the slider.
And coupling the load micro-actuator assembly to the actuator mounted head suspension assembly to create the head gimbal assembly. The invention includes the head gimbal assembly as a product of this process.

The invention's head stack assembly for the CSS hard disk drive includes a head stack coupling through an actuator arm to at least one of the head gimbal assemblies, and a main flex circuit electrically coupling to the flexure finger; wherein the main flex circuit includes an embedded circuit coupling for providing the pitch actuation control signal to the pitch actuator. The main flex circuit may further include a preamplifier providing the pitch actuation control signal to the pitch actuator, where the preamplifier receives a pitch control signal through the embedded circuit coupling to create the pitch actuation control signal.

The head stack may couple to at least two of the head gimbal assemblies. The main flex circuit may provide a first pitch actuation control signal to a first pitch actuator included in a first head gimbal assembly and provide a second pitch actuation control signal to a second pitch actuator included in a second head gimbal assembly. The preamplifier included in the main flex circuit may further provide the first pitch actuation control signal to the first pitch actuator and provide the second pitch actuation control signal to the second pitch actuator.

Alternatively, the main flex circuit may provide the pitch actuation control signal to both the first pitch actuator and the second pitch actuator. The preamplifier may further provide the pitch actuation control signal to both the first pitch actuator and the second pitch actuator.

The invention includes a method of manufacture for the head stack assembly, including coupling the head stack to the at least one head gimbal assembly to create a loaded head stack assembly and electrically coupling the main flex circuit to each of the head gimbal assemblies included in the loaded head stack assembly and to the embedded circuit coupling to create the head stack assembly. The invention further includes the head stack assembly as a product of this process.

The invention includes an embedded circuit for coupling to the invention's head stack assembly. The embedded circuit includes a matching coupling to the embedded circuit coupling for providing the pitch actuation control signal. The matching coupling may include one of the following: the matching coupling may be presented the pitch actuation control signal by a pitch actuator driver control by a pitch control signal, or the matching coupling may present the pitch control signal to the embedded coupling to provide the pitch actuation control signal.

The embedded circuit may further include means for receiving a humidity reading and a pressure reading creating a humidity estimate and a pressure estimate, means for determining a pitch angle estimate based upon the humidity estimate and based upon the pressure estimate, and means for asserting the pitch control signal when the pitch angle estimate is low. The means for receiving may further include means for receiving a temperature reading to create a temperature estimate, where the means for determining the pitch angle estimate may be further based upon the temperature estimate.

As used herein, the means group will consist of the means for receiving, the means for determining, and the means for asserting. At least one member of the means group includes at least one instance of a member of the group consisting of the following: a computer accessibly coupled to a memory and directed by a program system including at least one program step residing in the memory, a finite state machine, a neural network, and an inferential engine. As used herein, a computer includes at least one data processor and at least one instruction processor; wherein each of the data processors is at least partly directed by at least one of the instruction processors.

The program system may preferably include at least one of the following programming steps. Receiving the humidity reading and the pressure reading to create the humidity estimate and the pressure estimate. Determining the pitch angle estimate based upon the humidity estimate and based upon the pressure estimate. And asserting the pitch control signal when the pitch angle estimate is low.

The program system directing at least one of the instances of the computer may include at least one of the following program steps. Positioning the slider for a read-write head to follow a track on the disk surface, where the slider includes the read-write head. Encoding data to create a write data stream used by the read-write head to write to the track. And/or decoding a raw data received from the read-write head reading the track.

The embedded circuit may preferably include an integrated circuit containing the means for receiving the humidity reading and the pressure reading creating the humidity estimate and the pressure estimate, the means for determining the pitch angle estimate based upon the humidity estimate and based upon the pressure estimate, and the means for asserting the pitch control signal when the pitch angle estimate is low.

The invention includes a method of manufacturing the embedded circuit, which includes one of the following: electrically coupling the matching coupling and the integrated circuit to create the embedded circuit for providing the pitch control signal through the matching coupling, or electrically coupling the matching coupling, the pitch actuator driver, and the integrated circuit to create the embedded circuit for providing the pitch actuation control signal through the matching coupling. The embedded circuit as a product of this manufacturing process.

The invention's CSS hard disk drive includes the head stack assembly electrically coupling through the embedded circuit coupling to the matching coupling of the embedded circuit, and the head stack assembly pivotably mounted to a disk base through an actuator pivot in the head stack to position the slider included in the head gimbal assembly near the disk surface of the disk rotatably mounted on a spindle motor coupled to the disk base.

The CSS hard disk drive may further, preferably include a humidity sensor and a pressure sensor located near the disk and both of the humidity sensor and the pressure sensor communicatively couple to a means for receiving a humidity reading from the humidity sensor and a pressure reading from the pressure sensor, where the embedded circuit includes the means for receiving and the embedded circuit uses the humidity reading and the pressure reading to at least partly generate for assertion the pitch control signal. The CSS hard disk drive may further, preferably include a temperature sensor located near the disk and communicatively coupled to the means for receiving a temperature reading from the temperature sensor, where the embedded circuit further uses the temperature reading to at least partly generate for assertion the pitch control signal.

The invention includes method of manufacturing the CSS hard disk drive by electrically coupling the head stack assembly through the embedded circuit coupling to the matching coupling of the embedded circuit and pivotably mounting the head stack assembly to the disk base through the actuator pivot to position the slider near the disk surface to create the CSS hard disk drive. The invention includes the CSS hard disk drive as a product of this manufacturing process.

### BRIEF DESCRIPTION OF THE DRAWINGS

FIGS. 1A to 1C show the problem which can occur when the humidity is high and/or the pressure low for a slider of a CSS hard disk drive regarding its pitch angle;

FIGS. 2A to 2D show the basic operation of the invention's head gimbal assembly include the invention's pitch actuator;

FIGS. 3A to 3D show the basic operation of the invention where the pitch actuator includes an electrostatic coupling;

FIGS. 4A to 4C show the basic operation of the invention where the pitch actuator includes a piezoelectric stack;

FIGS. 4D to 4F show the basic operation of the invention where the pitch actuator includes the piezoelectric stack coupling to the flexure finger toward the disk surface;

FIGS. 5A and 5B show various aspects of the invention's head gimbal assembly;

FIGS. 6A and 6B show various aspects of the invention's CSS hard disk drive;

FIGS. 7A to 9B show various aspects of the invention's actuator arm;

FIGS. 10 to 12 show various aspects of the invention's CSS hard disk drive;

FIGS. 13A and 13B show an example of a micro-actuator assembly employing an electrostatic effect;

FIGS. 14 and 15 show some aspects of the invention's embedded circuit and the CSS hard disk drive;

FIGS. 16A to 17D show some details of the aspects of the embedded circuit of FIGS. 14 and 15;

FIG. 18 shows some details of the CSS hard disk drive of the previous Figures;

FIGS. 19A to 20B show some further details of the invention's head gimbal assembly;

FIGS. 20C and 20D show some details of the track on the disk surface of the previous Figures;

FIG. 21A shows the embedded circuit of FIG. 14 including an integrated circuit containing all the members of the invention's means group; and

FIG. 21B shows the actuator mounted head suspension assembly used in some embodiments of the method of manufacturing the invention's head gimbal assembly.

### DETAILED DESCRIPTION

This invention relates to the read-write head to disk interface in a CSS hard disk drive, in particular to active control of the pitch angle of the slider containing the read-write head to the rotating disk surface in a Contact Start-Stop CSS hard disk drive, particularly in response to the air pressure as associated with altitude and in response to humidity.

The inventors considered the effects of humidity, often in conjunction with pressure and/or temperature, with regards to the issues of tipping in a Contact Start-Stop (CSS) CSS hard disk drive. They have found methods and apparatus which can alter the pitch angle of the slider to correct for these problems.

The invention improves the reliability and performance of a read-write head 94 by adapting the pitch angle of its slider 90 when the air bearing surface 92 uses at least one Pad with Diamond Like Carbon (PDLC), which will be referred to as a pad PDLC. The invention includes a method of adapting the pitch angle PA of the slider 90 to the rotating disk surface 120-1. This method reduces the probability of undesirable pad contacts with the disk surface under various altitude and humidity conditions.

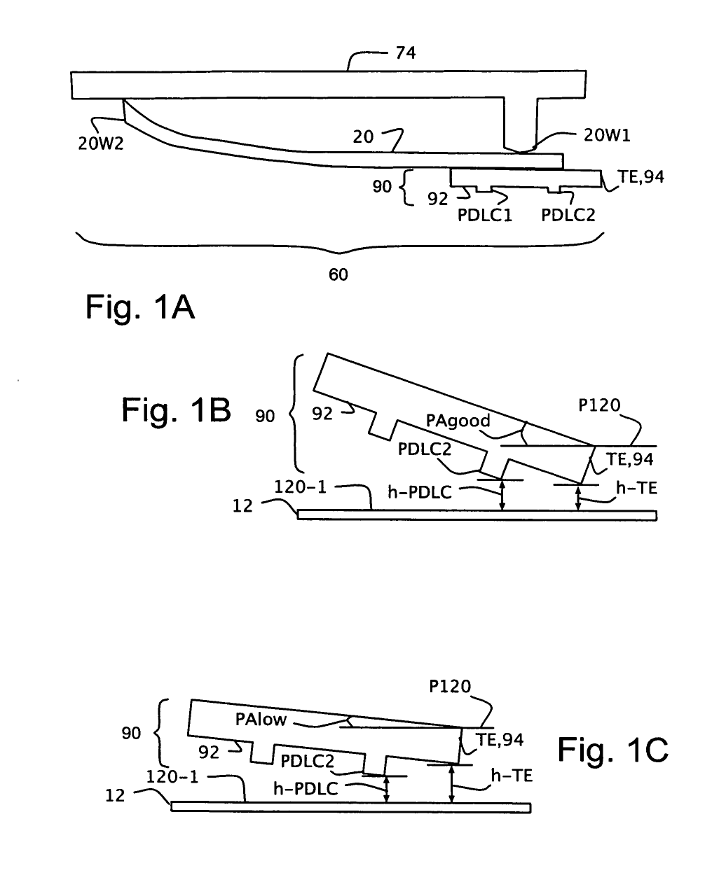

As shown in FIG. 1A, the bottom surface of the flexure finger 20 may typically be glued to the top surface of the slider 90, allowing the slider freedom of motion in both pitch and roll directions. The sliders typically used in a CSS hard disk drive 10 typically use at least one pad PDLC applied to the air bearing surface 92 to reduce stiction during start-up by decreasing the nominal contact area between the slider and the disk surface 120-1.

The typical height of the pad PDLC above the air bearing surface 92 is between 25 and 30 nanometers (nm) and a slider 90 may include more than five pads on the air bearing surface. The location and height of the pads are constrained by several performance and/or reliability requirements. The pads often need to be located so as to minimize interference with the disk surface 120-1 when the slider is flying above the rotating disk surface during normal access operations, for instance, by one or more of the pads contacting the rotating disk surface. While it is good to locate the pads near the trailing edge TE to minimizing tipping, the closer the pads are to the trailing edge, the greater the chance of pad contact with the rotating disk surface.

In normal ambient operating conditions, as shown in FIG. 1B, the pitch angle PA is a good pitch angle PAgood, which is enough to make minimum clearance location at read-write head 94 location, which is close to the trailing edge TE. However, as shown in FIG. 1C, when the pitch angle drops to a shallow pitch angle PAlow due to low pressure and/or high humidity conditions, this can result in undesirable “early” pad contact with the rotating disk surface 120-1. The reason why this pad contact is undesirable is that if there was no pitch angle drop, as shown in FIG. 1B, the minimum clearance location still would be at trailing edge and not at the pads, and there would be more margin between the flying height at trailing edge h-TE and the flying height at pad h-PDLC making it unlikely that there would be contact between the slider and the rotating disk surface, unless the altitude and/or the humidity conditions change for the worse. Consequently, the inventors realized that the pitch angle needed to be adjusted when the CSS hard disk drive 10 encounters certain altitude and humidity conditions.

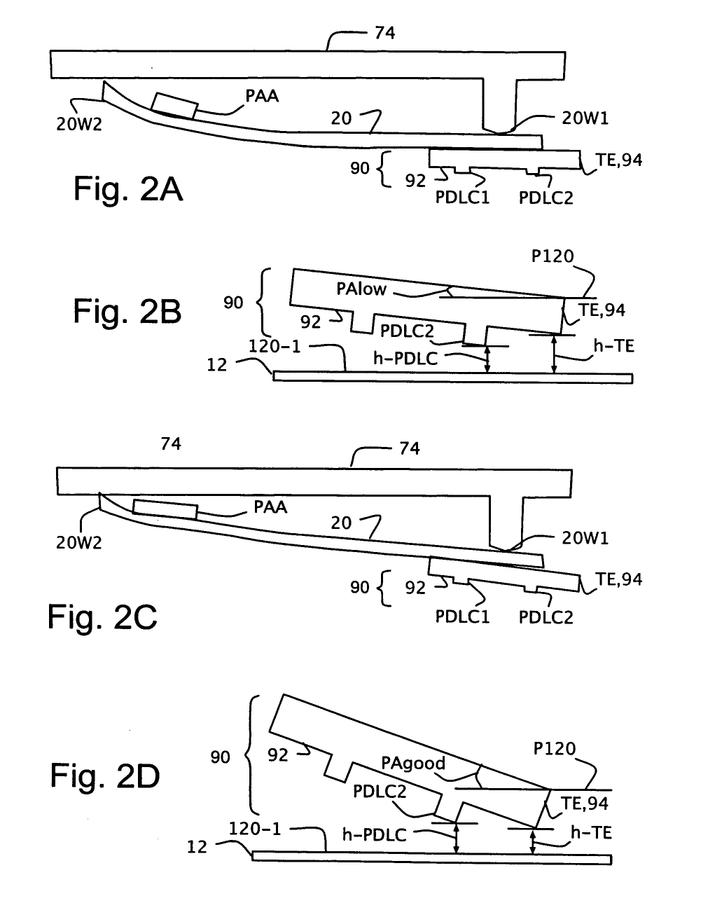

The invention operates a head gimbal assembly 60 in a CSS hard disk drive 10 by asserting a pitch actuation control signal PACS provided to at least one electrical coupling of a pitch actuator PAA as shown in FIGS. 2A to 2D. The pitch actuator responds to the pitch actuation control signal by flexing the flexure finger 20 toward the load beam 74 to increase the pitch angle PA of the slider 90 to a disk surface 120-1. The slider includes at least one Pad with Diamond Like Carbon, which will frequently be referred to as a pad PDLC on an air bearing surface 92 for use in parking the slider on the disk surface in the CSS hard disk drive.

An example of the method of adjusting the pitch angle PA is shown in FIGS. 2A to 2D. To increase the pitch angle, the flexure finger 20 is attracted to the load beam 74. FIG. 2A shows the pitch actuator PAA inactive, and gravity and other ambient conditions tending to lower the flexure finger. In certain conditions, such as the low pressure of high altitude and/or high humidity, the pitch angle is too low, which is designated as shallow pitch angle PAlow, as shown in FIG. 2B. In such situations, the pad PDLC tends to have too high a probability of contacting the rotating disk surface 120-1, which can result in damage to the read-write head 94 and/or the disk surface. FIG. 2C shows the pitch actuator activated attracting the flexure finger to the load beam, and consequently increasing the pitch angle to a good pitch angle PAgood, as shown in FIG. 2D.

The invention's head gimbal assembly 60 implements this method of operation, and includes first coupling of the load beam 74 to the flexure finger 20 at a flexure coupling point 20W2, a second coupling of the load beam, the flexure finger and the slider 90 at a dimple 20W1, and the pitch actuator PAA coupling to the flexure finger between the flexure coupling point and the dimple. The flexure finger may include at least one pitch actuation control signal trace PACST for providing the pitch actuation control signal PACS to the pitch actuator.

The pitch actuator PAA may include an electrostatic coupling EC responding to the pitch actuation control signal PACS to urge the flexure finger 20 toward the load beam 74 to flex the flexure finger. The electrostatic coupling includes a first plate P1 coupled to the flexure finger interacting with a second plate P2 coupled to the load beam to attract the flexure finger to the load beam. The load beam may include the second plate. The flexure finger may include the first plate.

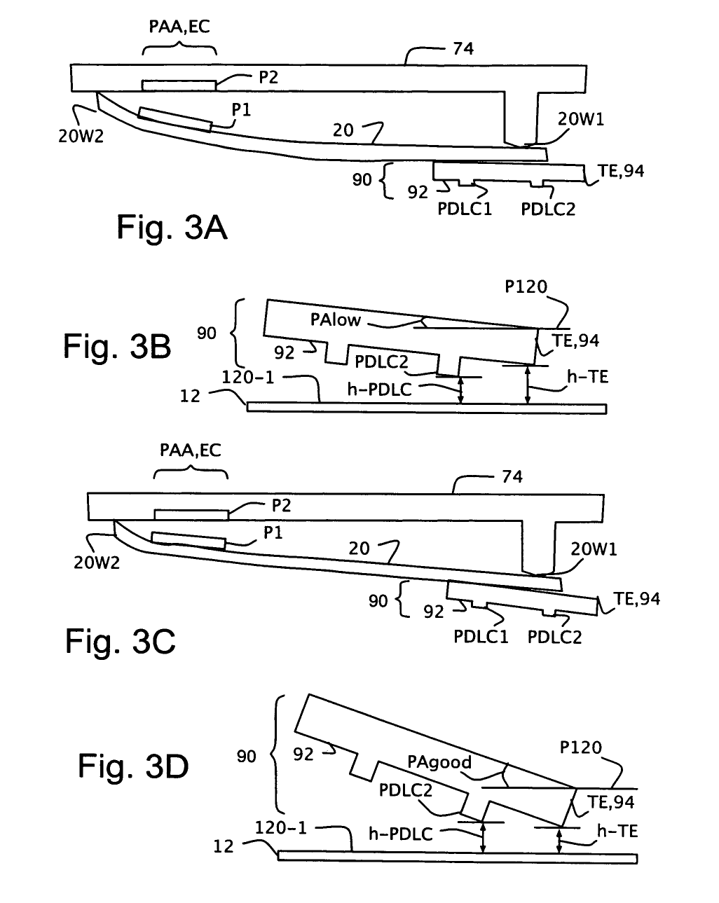

An example of the pitch actuator PAA including an electrostatic coupling EC is shown in FIGS. 3A to 3D. To increase the pitch angle PA, the flexure finger 20 is attracted to the load beam 74. FIG. 3A shows the electrostatic coupling is inactive, and gravity and other ambient conditions tending to lower the flexure finger. In certain conditions, the pitch angle is too low, which is designated as shallow pitch angle PAlow, as shown in FIG. 3B. In such situations, the pad PDLC tends to have too high a probability of contacting the rotating disk surface 120-1, which can result in damage to the read-write head 94 and/or the disk surface. FIG. 3C shows the electrostatic coupling activated, attracting the flexure finger to the load beam, and consequently increasing the pitch angle to a good pitch angle PAgood, as shown in FIG. 3D.

The invention's flexure finger 20 may include a first plate P1 arranged to electrostatically interact with a second plate P2 included in the invention's load beam 74. The invention's head gimbal assembly 60 includes the slider coupling point to the flexure finger to create an electrostatic coupling EC between the first plate and the second plate capable of attracting the flexure finger to the load beam. The head gimbal assembly also includes at least one pitch actuation control signal trace PACST electrically coupling to the first plate and possibly a second trace electrically coupling to the second plate to provide the electromagnetic force between the two plates, which creates the electrostatic field between them activating the electrostatic coupling EC.

The pitch actuator PAA may include a piezoelectric stack PZ coupling to the flexure finger 20 to urge the flexure finger toward the load beam 74 to flex the flexure finger, when the piezoelectric stack is stimulated by the pitch actuation control signal PACS.

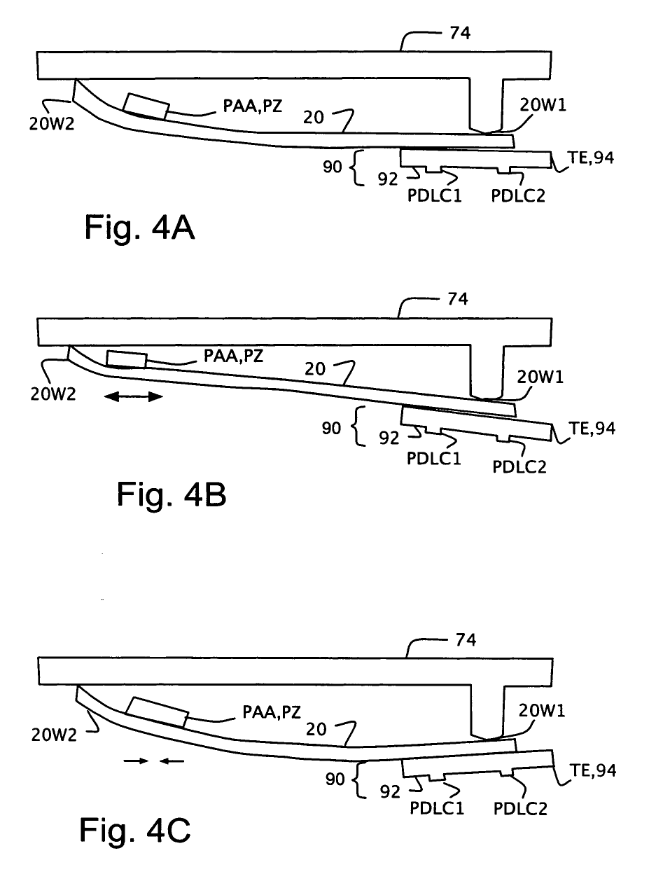

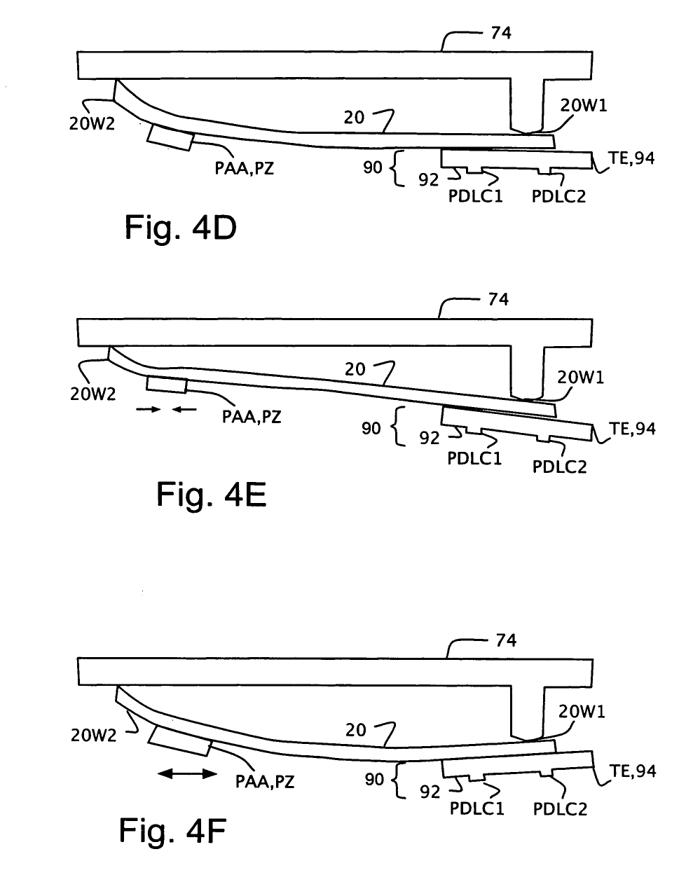

A first example of the pitch actuator PAA including the piezoelectric stack PZ is shown in FIGS. 4A to 4C with the piezoelectric stack coupled to the side of the flexure finger 20 toward the load beam 74. A second example shows the piezoelectric stack coupled to the side of the flexure finger away from the load beam in FIG. 4D to 4F. FIGS. 4A and 4D show the piezoelectric stack inactive, and gravity and other ambient conditions tending to lower the flexure finger. FIGS. 4C and 4E show the piezoelectric stack activated, and be contracting attracting the flexure finger to the load beam. Additionally, FIGS. 4B and 4F show the piezoelectric stack expanding, moving the flexure finger away from the load beam and lowering the pitch angle.

In certain embodiments of the invention, lowering the pitch angle PA may be counterproductive, and the head gimbal assembly 60, in particular, the flexure finger 20 may provide exactly one trace, the pitch actuation control signal trace PACST to drive one of the two terminals of the piezoelectric stack, while the second terminal is tied to a shared ground, which may include at least part of the load beam. Something similar to this can also be done with embodiments employing the electrostatic coupling EC mentioned above.

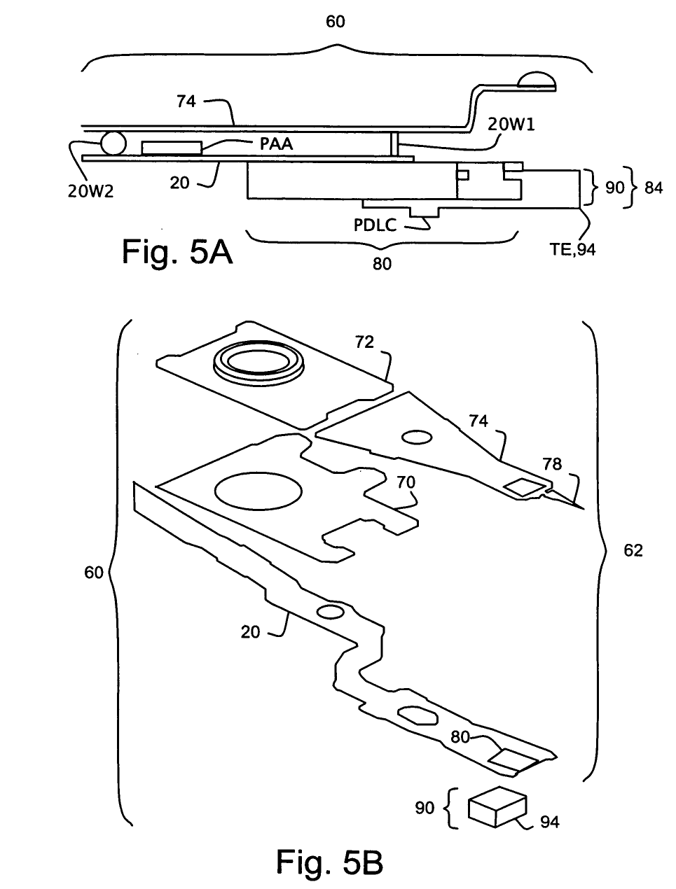

In further detail, FIG. 5A shows a side view of the head gimbal assembly 60 with a micro-actuator assembly 80 for aiding in laterally positioning of the slider 90. In certain embodiments, the micro-actuator assembly may employ a piezoelectric effect and/or an electrostatic effect and/or a thermal mechanical effect. The head gimbal assembly may preferably include a base plate 72 coupled through a hinge 70 to the load beam 74. Often the flexure finger 20 is coupled to the load beam and the micro-actuator assembly 80 and slider 90 are coupled through the flexure finger to the head gimbal assembly.

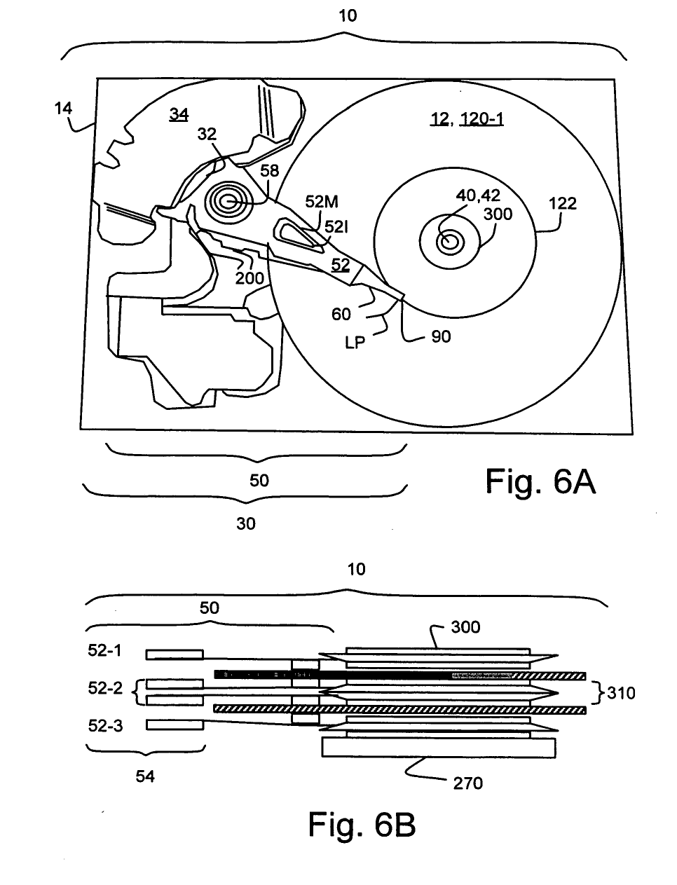

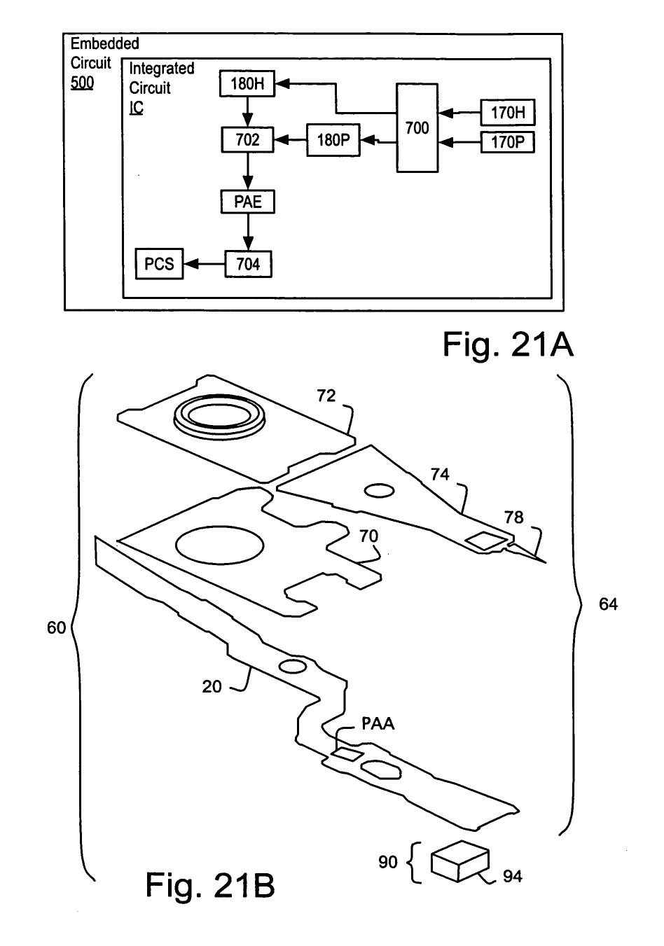

The head gimbal assembly 60, preferably includes a load tab 78 as shown in FIGS. 5B and 21B, coupling through a load beam 74 to engage the slider 90, where the load tab contacts a tab ramp 312 away from the slider, as shown in FIG. 6B. The tab ramps preferably serve as a cam through contacting the load tabs of head gimbal assemblies to engage their sliders into secure contact with their neighboring disk surfaces during non-operation periods.

The disk clamp 300 may preferably support parking the sliders on disk surfaces by including a third tab ramp. The spindle motor 270 may preferably support parking the sliders on disk surfaces by including a fourth tab ramp. The disk spacer 310 preferably supports parking the sliders on disk surfaces by including a third tab ramp radially mounted to a fourth tab ramp, which form a radially symmetric triangular extension from the disk spacer about the spindle shaft center 42.

The CSS hard disk drive 10 may further include a second disk surface 120-2 for access by a second head gimbal assembly 60-2 including a third load tab 78-3 for contact with a third tab ramp near the far inside diameter ID of the second disk surface. The CSS hard disk drive may further include a disk clamp 300 containing the first tab ramp and a spindle motor 270 containing the second tab ramp.

The CSS hard disk drive 10 may further include a disk spacer 310 including a third tab ramp 312-3 facing the second disk surface 120-2 and coupling to a fourth tab ramp 312-4 facing a third disk surface 120-3 included in a second disk 12-2, a third head gimbal assembly 60-3 including a third load tab 78-3 for contacting the third tab ramp to engage a third slider 60-3 into the secure contact of the second disk surface, and a fourth head gimbal assembly 60-4 including a fourth load tab 78-4 facing the third disk surface.

The invention's head gimbal assembly 60 may be manufactured by any of several steps. Coupling the pitch actuator PAA and the slider 90 to the flexure finger 20 included in a head suspension assembly 62 as shown in FIG. 5B to create the head gimbal assembly 60, where the head suspension assembly further includes the first coupling of the load beam 74, the flexure finger coupled at the flexure coupling point 20W2 as shown in FIGS. 1A, 2A, 2C, 3A, 3C, and 4A to 5A.

Another example manufacturing step for the head gimbal assembly includes coupling an actuator mounted head suspension assembly 64 as shown in FIG. 21B to the slider 90 to create the head gimbal assembly 60, where the actuator mounted head suspension assembly includes the pitch actuator PAA coupled to the flexure finger 20 included in the head suspension assembly 62.

Another example manufacturing step for the head gimbal assembly includes coupling the pitch actuator PAA and a loaded micro-actuator assembly 84 to the head suspension assembly 62 to create the head gimbal assembly 60, where the loaded micro-actuator assembly includes a micro-actuator assembly 80 coupled to the slider 90.

And another example manufacturing step for the head gimbal assembly includes coupling the loaded micro-actuator assembly 84 to the actuator mounted head suspension assembly 64 to create the head gimbal assembly 60.

Manufacturing the head gimbal assembly 60 may further include coupling the load beam 74 including the load tab 78 through a flexure finger 20 to the slider 90 to create the head gimbal assembly. Note that the flexure finger 20 may include one or more stiffening components made of at least one stainless steel layer, which are often made by gluing and/or welding a sheet of stainless steel to the flexure finger blank, and then cutting, stamping, and/or etching the result to create the flexure finger.

The invention includes the head gimbal assembly 60 as a product of this process.

The invention's head stack assembly 50 for the CSS hard disk drive 10 includes a head stack 54 coupling through an actuator arm 52 to at least one head gimbal assembly 60, and a main flex circuit 200 electrically coupling to the flexure finger 20, where the main flex circuit includes an embedded circuit coupling ECC for providing the pitch actuation control signal PACS to the pitch actuator PAA. The main flex circuit may further include a preamplifier 24 providing the pitch actuation control signal to the pitch actuator, where the preamplifier receives a pitch control signal PCS through the embedded circuit coupling to create the pitch actuation control signal.

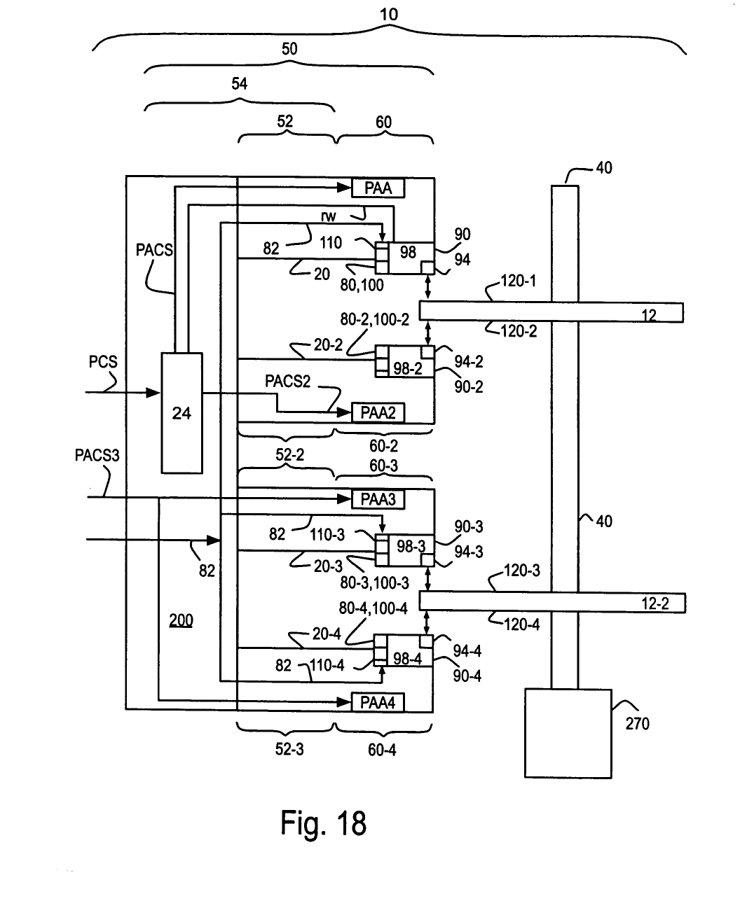

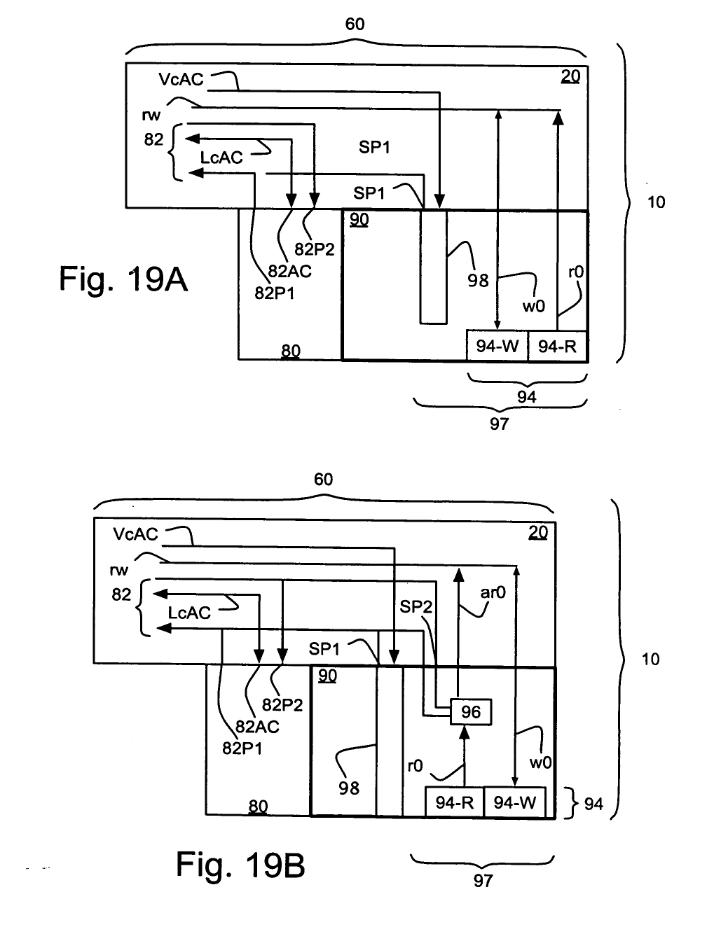

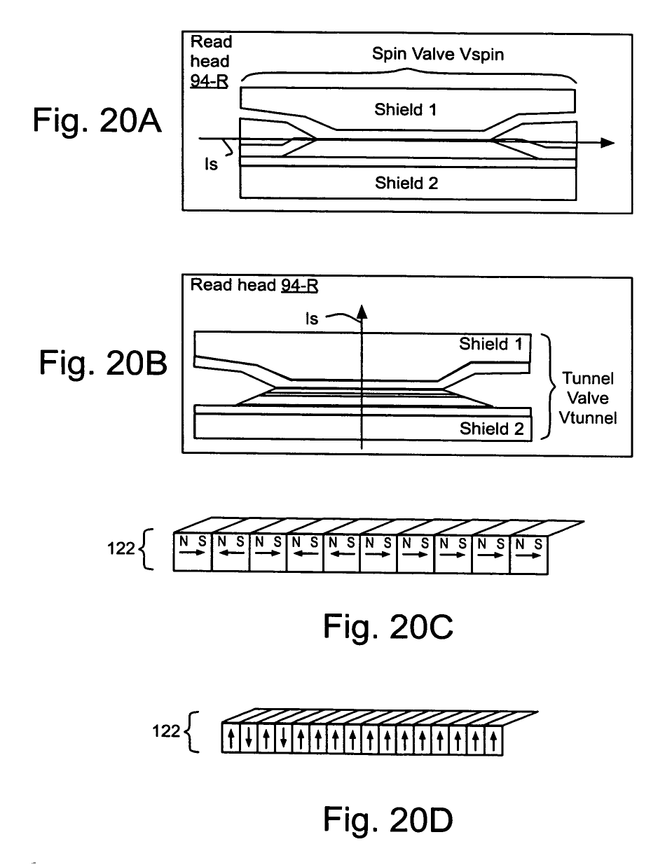

The head stack 54 may couple to at least two of the head gimbal assemblies. By way of example, consider FIG. 18 showing the head stack 54 including the actuator arm 52, a second actuator arm 52-2 and a third actuator arm 52-3, coupling to the head gimbal assembly 60, a second head gimbal assembly 60-2, a third head gimbal assembly 60-3, and a fourth head gimbal assembly 0-4. The second actuator arm coupled to the second head gimbal assembly and a third head gimbal assembly 60-3, and the third actuator arm coupled to the fourth head gimbal assembly. The second head gimbal assembly includes the second load tab 78-2 for engaging the second slider 90-2. The third head gimbal assembly includes the third load tab 78-3 for engaging the third slider 90-3. And the fourth head gimbal assembly includes the fourth load tab 78-4 for engaging a fourth slider 90-4.

The main flex circuit 200 may provide the pitch actuation control signal PACS to the pitch actuator PAA included in the head gimbal assembly 60 and provide a second pitch actuation control signal PACS-2 to a second pitch actuator PAA2 included in a second head gimbal assembly 60-2. The preamplifier 24 included in the main flex circuit may further provide the pitch actuation control signal to the first pitch actuator and provide the second pitch actuation control signal to the second pitch actuator.

Alternatively, the main flex circuit 200 may provide the same pitch actuation control signal PACS3 to both pitch actuators, for example, to the third pitch actuator PAA3 included in the third head gimbal assembly 60-3 and to the fourth pitch actuator PAA4 included in the fourth head gimbal assembly 60-4. The preamplifier 24 may further provide the pitch actuation control signal to both the first pitch actuator and the second pitch actuator.

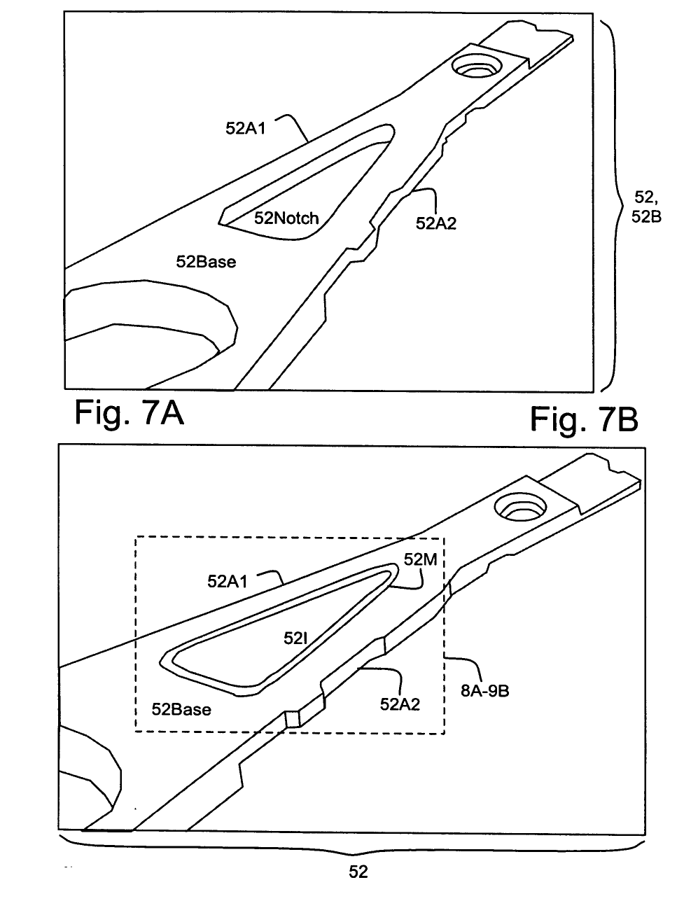

An actuator arm 52 tends to include an actuator notch 52Notch made from an actuator arm base 52Base coupling through a first actuator arm bridge 52A1 and a second actuator arm bridge 52A2, which join together to hold the swage site 52S as shown in FIG. 7A. Conventional wisdom dictates that the actuator notch is useful in reducing the mass of the actuator arm, which retaining sufficient rigidity to perform its purpose of holding a head gimbal assembly over a rotating disk surface to access a track.

Alternatively, the actuator arm 52 may include an island 52I coupled through a mote 52M to at least two of an actuator base 52Base, a first actuator arm bridge 52A1, and a second actuator arm bridge 52A2, as shown in FIGS. 7B to 9B. The mote is preferably composed of a self-adhesive rubber and/or plastic, and the island may be composed of a metal, often preferred to be a non out-gassing metal such as a form of stainless steel. The actuator arm is preferably manufactured by providing the island coupling through the mote to at least two of the actuator base, the first actuator arm bridge and/or the second actuator arm bridge. Providing this may preferably be achieved through injection molding. The actuator arm is the product of this process.

The island 52I may couple through the mote to each of the actuator base, the first actuator arm bridge and the second actuator arm bridge. The mote may be composed of a single connected component, or multiple separate connected components. The mote may or may not surround the island. The island may not couple through the mote to each of the actuator base, the first and the second actuator arm bridge, for example, the coupling through the mote may be to the first and second actuator arm bridges, but not to the actuator base.

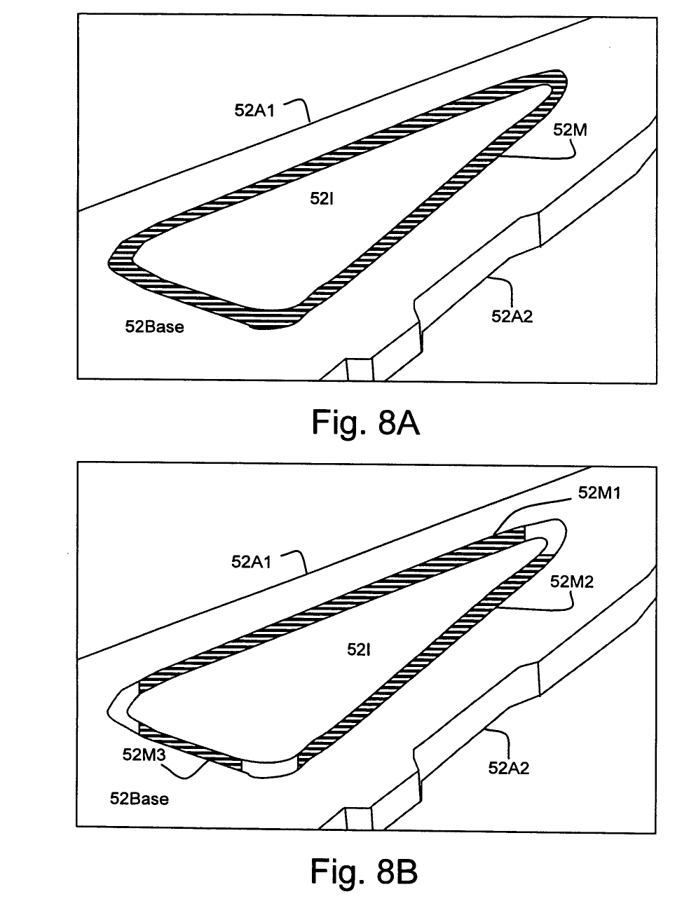

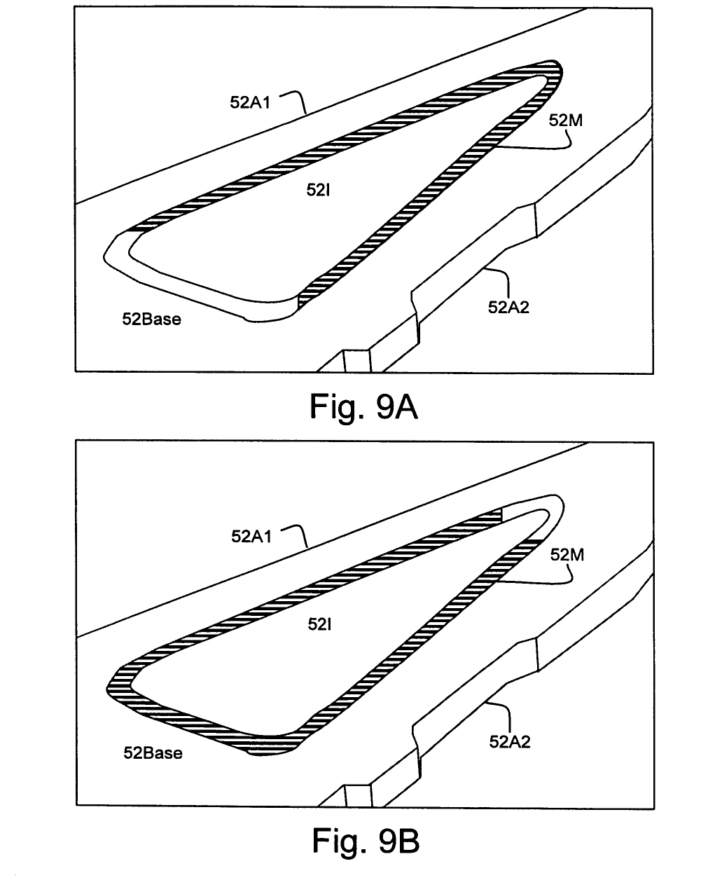

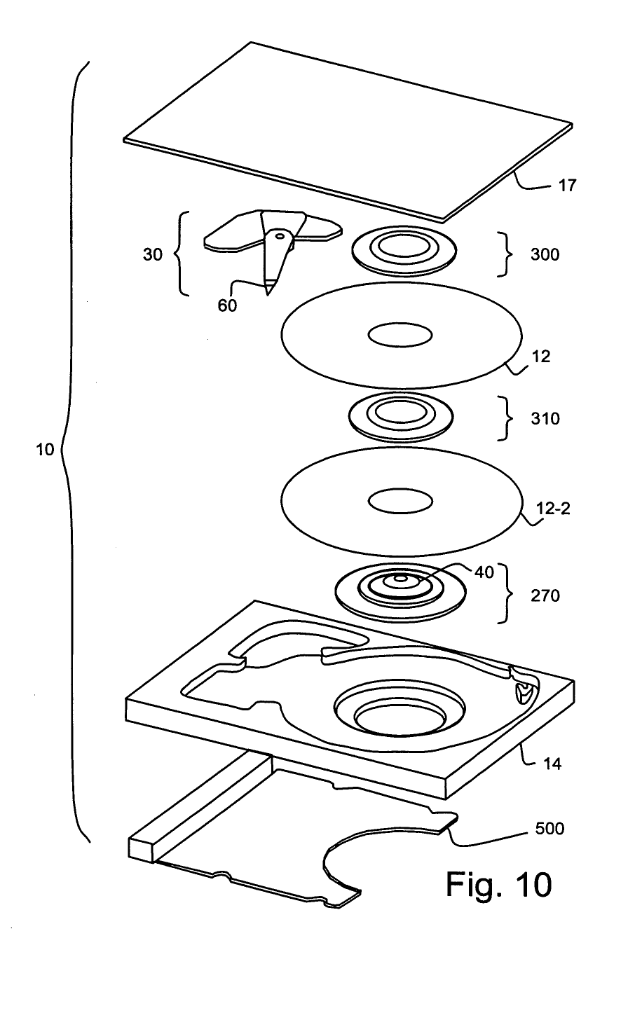

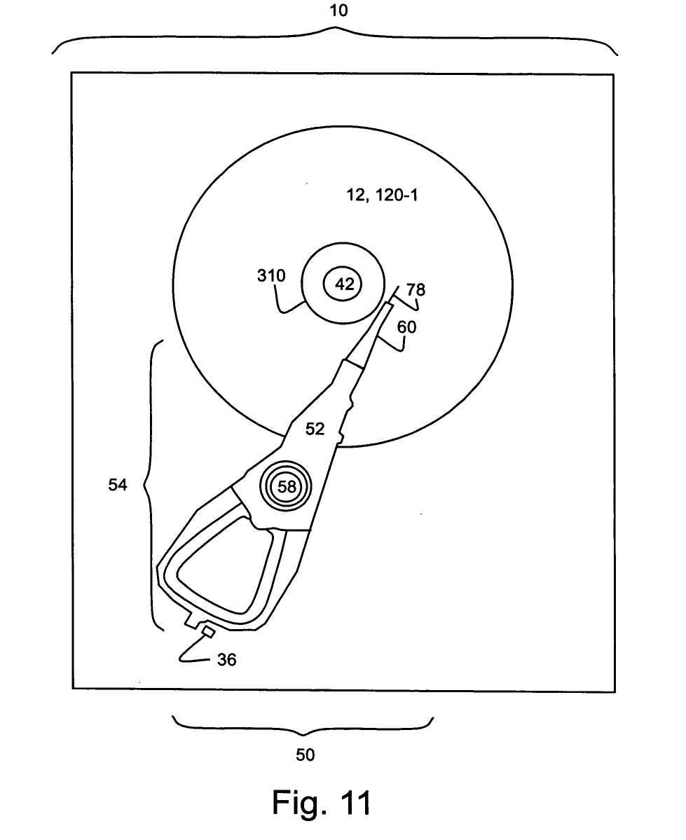

FIG. 7B shows the general relationship between the island 52I coupling through the mote 52M to at least two of the actuator base 52Base, the first actuator arm bridge 52A1 and the second actuator arm bridge 52A2. FIGS. 8A to 9B show various alternative embodiments, which are provided as examples of various embodiments and not as an exhaustive catalog.

FIG. 8A shows the island 52I coupling through the mote 52M to each of the actuator base 52Base, the first actuator arm bridge 52A1 and the second actuator arm bridge 52A2.

FIG. 8B shows alternative to the actuator arm 52 of FIG. 8A including the island 52I coupling through the mote 52M to each of the actuator base 52Base, the first actuator arm bridge 52A 1 and the second actuator arm bridge 52A2. In this embodiment, the mote is formed of a first mote component 52M1, a second mote component 52M2 and a third mote component 52M3, each of which is a separate connected component.

FIG. 9A shows another embodiment of the actuator arm 52 of FIG. 7B including the island 52I coupling through the mote 52M to each of the first actuator arm bridge 52A1 and the second actuator arm bridge 52A2, and not coupling to the actuator base 52Base.

FIG. 9B shows alternative to the actuator arm 52 of FIG. 8A including the island 52I coupling through the mote 52M to each of the actuator base 52Base, the first actuator arm bridge 52A1 and the second actuator arm bridge 52A2. In this embodiment, the mote is formed of a just one connected component, but does not surround the island as it does in FIG. 8A.

The invention includes a method of manufacture for the head stack assembly 50, including coupling the head stack 54 to at least one head gimbal assembly 60 to create a loaded head stack assembly and electrically coupling the main flex circuit 200 to each of the head gimbal assemblies included in the loaded head stack assembly and to the embedded circuit coupling ECC to create the head stack assembly. The invention further includes the head stack assembly as a product of this process.

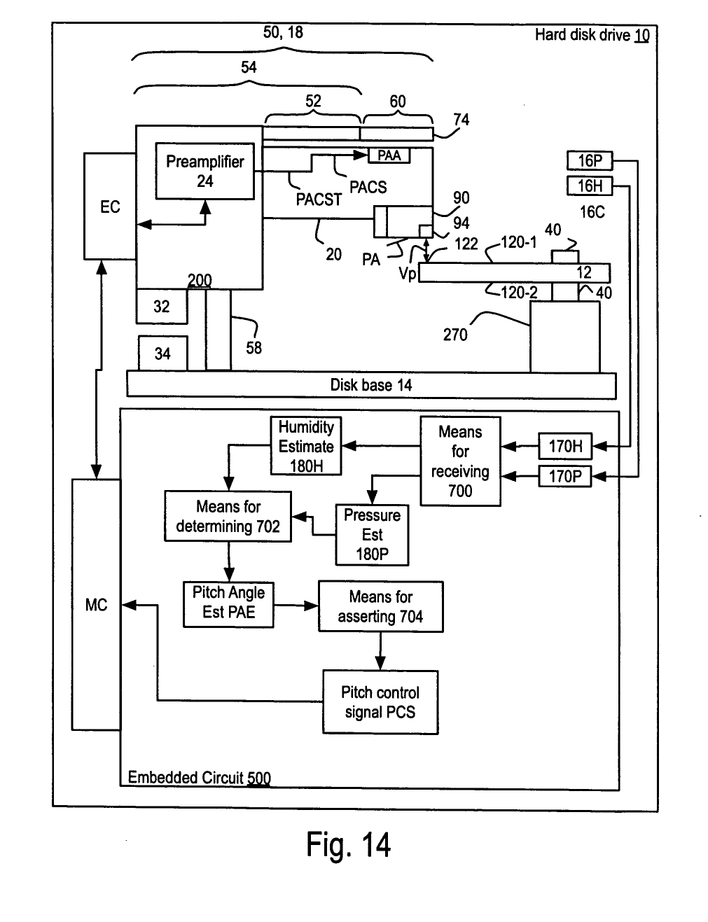

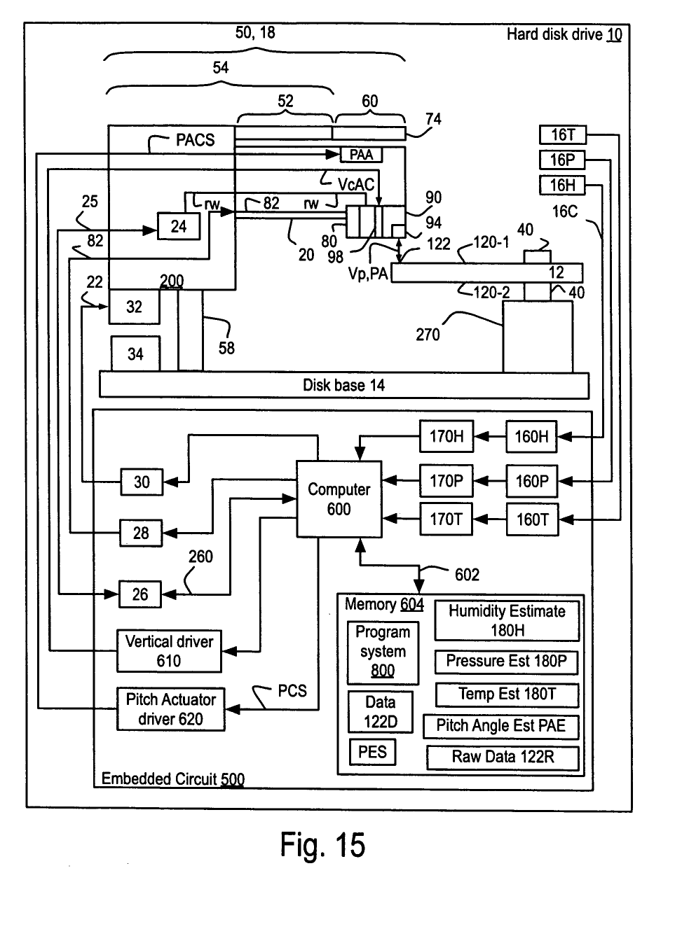

The invention includes an embedded circuit 500 for coupling to the invention's head stack assembly 50. The embedded circuit includes a matching coupling MAC to the embedded circuit coupling ECC for providing the pitch actuation control signal PACS as shown in FIG. 14. In FIGS. 15 and 18, the embedded circuit coupling and the matching coupling are not separately shown. Instead the signal between the coupling is shown on the left hand side of these Figures. The matching coupling may include one of the following: the matching coupling may be presented the pitch actuation control signal PACS by a pitch actuator driver 620 by a pitch control signal PCS, or the matching coupling may present the pitch control signal to the embedded coupling to provide the pitch actuation control signal.

The embedded circuit 500 may further include means for receiving 700 a humidity reading 170H and a pressure reading 170P creating a humidity estimate 180H and a pressure estimate 180P, means for determining 702 a pitch angle estimate PAE based upon the humidity estimate and based upon the pressure estimate, and means for asserting 704 the pitch control signal PCS when the pitch angle estimate is low, as shown in FIG. 14.

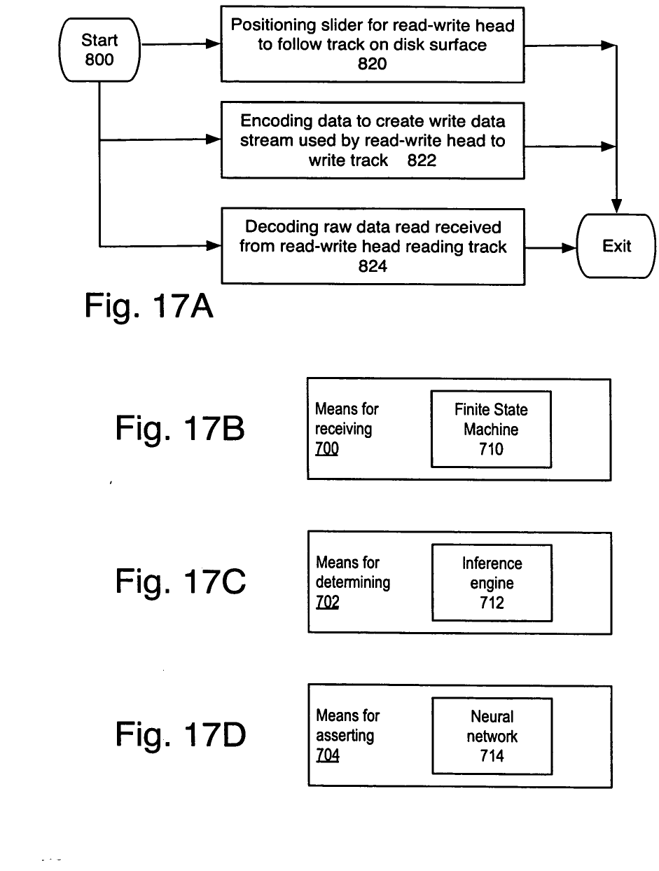

As used herein, the means group will consist of the means for receiving 700, the means for determining 702, and the means for asserting 704. At least one member of the means group includes at least one instance of a member of the group consisting of the following: a computer 600 accessibly coupled 602 to a memory 604 and directed by a program system 800 including at least one program step residing in the memory as shown in FIG. 15, a finite state machine 710 as shown in FIG. 17B, a neural network 714 as shown in FIG. 17D, and an inferential engine 712 as shown in FIG. 17C. As used herein, a computer includes at least one data processor and at least one instruction processor; wherein each of the data processors is at least partly directed by at least one of the instruction processors.

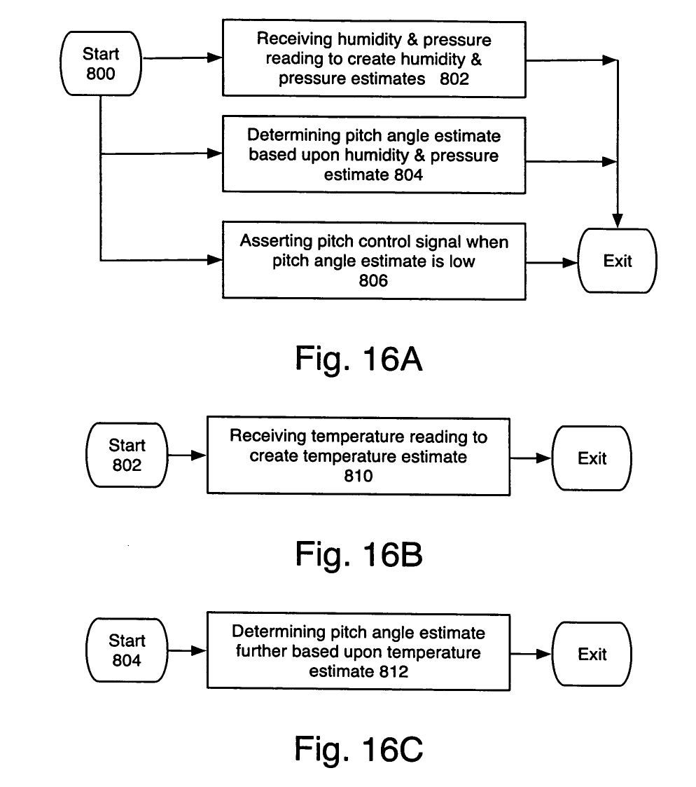

The program system 800 may preferably include at least one of the following programming steps as shown in FIG. 16A. Operation 802 supports receiving 700 the humidity reading 170H and the pressure reading 170P to create the humidity estimate 180H and the pressure estimate 180P. Operation 804 supports determining 702 the pitch angle estimate PAE based upon the humidity estimate 180H and based upon the pressure estimate 180P. And operation 806 supports asserting 704 the pitch control signal PCS when the pitch angle estimate is low.

The means for receiving 700 may further include means for receiving a temperature reading 170T to create a temperature estimate 180T, where the means for determining the pitch angle estimate may be further based upon the temperature estimate, as shown in FIG. 15 and further shown in FIGS. 16A and 16B.

The program system 800 directing at least one of the instances of the computer 600, may include at least one of the following program steps as shown in FIG. 17A. Operation 820 supports positioning the slider 90 for its read-write head 94 to follow a track 122 on the disk surface 120-1, where the slider includes the read-write head. Operation 822 supports encoding track data 122D for use by the read-write head to write to the track. And/or operation 824 supporting decoding a raw data 122R received from the read-write head reading the track.

Operation 820 may further include the voice coil motor 30 including the head stack assembly 50 to position the slider 90 for its read-write head 94 to follow a track 122 on the rotating disk surface 120-1.

The embedded circuit 500 may preferably include an integrated circuit IC containing the means for receiving 700 the humidity reading 170H and the pressure reading 170P creating the humidity estimate 180H and the pressure estimate 180P, the means for determining 702 the pitch angle estimate PAE based upon the humidity estimate 180H and based upon the pressure estimate 180P, and the means for asserting 704 the pitch control signal PCS when the pitch angle estimate is low as shown in FIG. 21A.

The invention includes a method of manufacturing the embedded circuit 500, which includes one of the following: electrically coupling the matching coupling MAC and the integrated circuit IC to create the embedded circuit for providing the pitch control signal PCS through the matching coupling, or electrically coupling the matching coupling, the pitch actuator driver 620, and the integrated circuit to create the embedded circuit for providing the pitch actuation control signal PACS through the matching coupling. The invention includes the embedded circuit as a product of this manufacturing process.

The invention's CSS hard disk drive 10 includes the head stack assembly 50 electrically coupling through the embedded circuit coupling ECC to the matching coupling MAC of the embedded circuit 500, and the head stack assembly pivotably mounted to a disk base 14 through an actuator pivot 58 in the head stack 54 to position the slider 90 included in the head gimbal assembly 60 near the disk surface 120-1 of the disk 12 rotatably mounted on a spindle motor 270 coupled to the disk base.

The CSS hard disk drive 10 may further, preferably include the humidity sensor 16H and the pressure sensor 16P located near the disk 12 and both of the humidity sensor and the pressure sensor communicatively couple to a means for receiving 700 the humidity reading 170H from the humidity sensor and the pressure reading 170P from the pressure sensor, where the embedded circuit 500 includes the means for receiving and the embedded circuit uses the humidity reading and the pressure reading to at least partly generate for assertion the pitch control signal PCS. The CSS hard disk drive may further, preferably include a temperature sensor 16T located near the disk and communicatively coupled to the means for receiving a temperature reading 170T from the temperature sensor, where the embedded circuit further uses the temperature reading to further, at least partly, generate for assertion the pitch control signal.

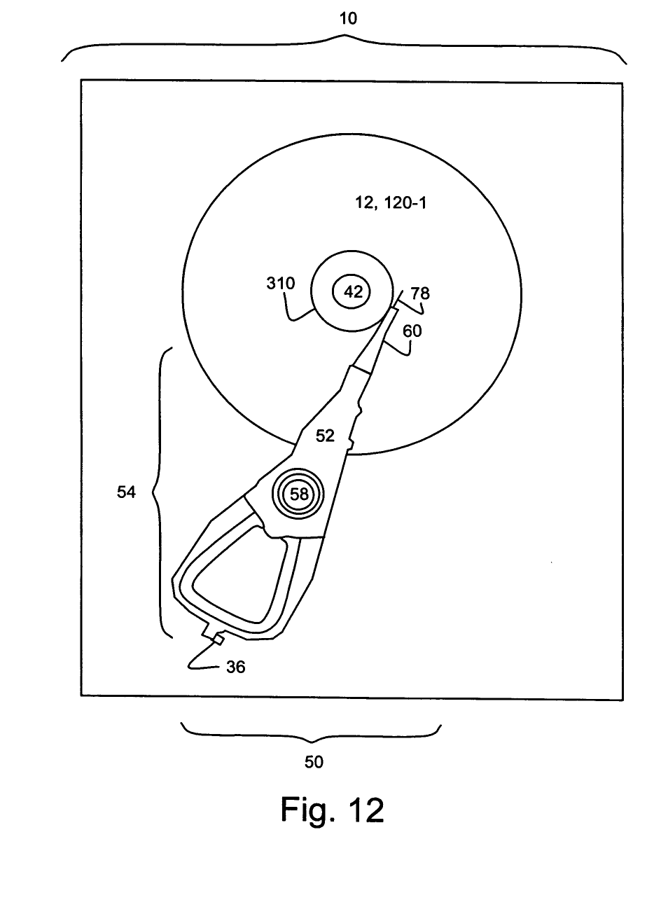

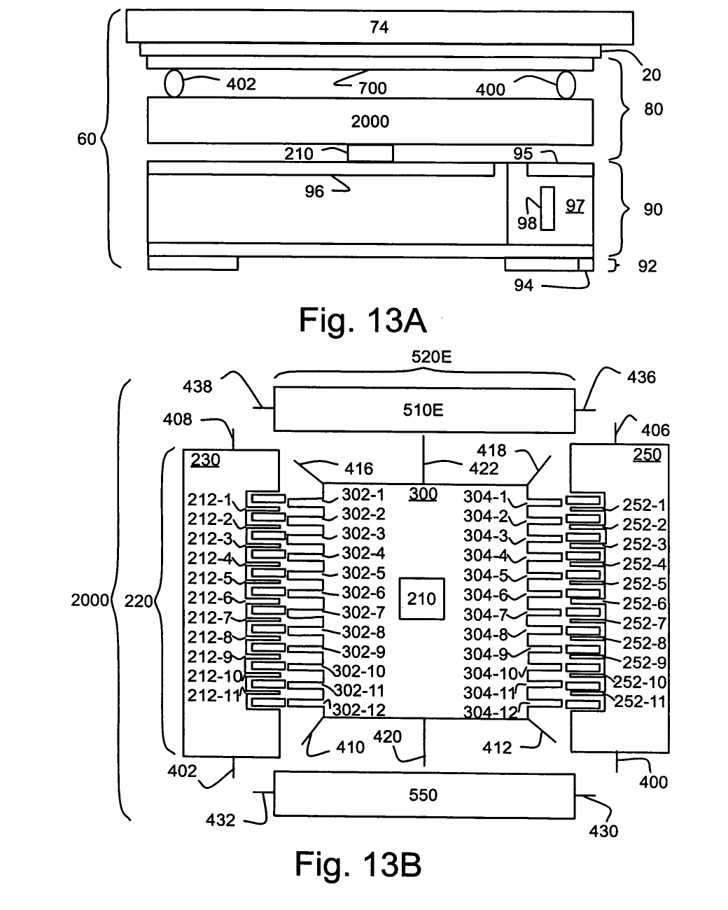

When in non-operational mode, the invention's CSS hard disk drive 10 parks the head stack assembly 50 with the head gimbal assemblies at the far inside diameter ID, shown in FIGS. 6A and 12, on the disk surfaces. The second load tab 78-2 contacts the first tab ramp of the disk spacer 310 engaging the second slider 90-2 into secure contact with the second disk surface 120-2. The second load tab 78-3 contacts the second tab ramp of the disk spacer engaging the third slider 90-3 into secure contact with the third disk surface 120-3. These tab ramps serve as a cam, contacting the load tabs to engage the sliders in secure contact with the disk surfaces no matter what the angular position of the head stack assembly or CSS hard disk drive. The sliders rest at the far inside diameter and because of the contact between the load tabs and tab ramps, are prevented from separating from the disk surfaces they rest on during a mechanical shock to the CSS hard disk drive.

In further detail, the second load tab 78-2 is included in the second head gimbal assembly 60-2. The third load tab 78-3 is included in the third head gimbal assembly 60-3. The head stack assembly 50 includes a first actuator arm 52-1 coupling to a first head gimbal assembly 60-1 including a first load tab 78-1 for contacting a third tab ramp 78-3 included in a disk clamp 300 to engage the first slider 90-1 into secure contact with the first disk surface 120-1. The head stack assembly further includes a second actuator arm 52-2 coupling to a second head gimbal assembly 60-2 and to a third head gimbal assembly 60-3.

The CSS hard disk drive 10 may further preferably operate as follows. Each slider 90 is moved a short distance away from its tab ramp 312 before starting the spindle motor 270 coupling to the disk(s) 12, and each of the sliders is moved the short distance away from the tab ramps before stopping the spindle motor. The short distance is at most one millimeter, and may preferably be about half a millimeter.

During starting and stopping of the CSS hard disk drive 10, the sliders, such as the second slider 90-2 and the third slider 90-3 are preferably moved slightly away from the tab ramp a short distance d to relieve the load applied by the load tabs contacting the tab ramps before the spindle motor 270 is turned on to rotate the disks, for example, the first disk 12-1 and the second disk 12-2. The short distance may preferably be about ½ millimeter. These operations prevent weakening the durability of the CSS hard disk drive 10. This movement may be accomplished through biasing the voice coil motor 30 against an inside diameter crash stop 36 as shown in FIG. 5, or by providing a two-position latch mechanism.

In normal operation the head stack assembly 50 pivots through an actuator pivot 58 to position at least one read-write head 94, embedded in a slider 90, over a rotating disk surface 120-1. The data stored on the rotating disk surface is typically arranged in concentric tracks. To access the data of a track 122, a servo controller first positions the read-write head by electrically stimulating the voice coil motor 30, which couples through the voice coil 32 and an actuator arm 52 to move a head gimbal assembly 60 in lateral positioning the slider close to the track as shown in FIG. 6A. Once the read-write head is close to the track, the embedded circuit typically enters an operational mode known herein as track following. It is during track following mode that the read-write head is used to access the data stored on the track.

The invention includes a method of manufacturing the CSS hard disk drive 10 by electrically coupling the invention's head stack assembly 50 through the embedded circuit coupling ECC to the matching coupling MAC of the invention's embedded circuit 500 and pivotably mounting the head stack assembly 50 to the disk base 14 through the actuator pivot 58 to position the slider 90 near the disk surface 120-1 to create the CSS hard disk drive. The invention includes the CSS hard disk drive as a product of this manufacturing process.

Manufacturing the CSS hard disk drive may include any combination of several processes. First, the CSS hard disk drive 10 including the first disk 12-1, may preferably be manufactured by rotatably coupling the disk between the disk clamp 300 and the spindle motor 270 about the spindle shaft center 42, placing the first tab ramp close to the first disk surface 120-1 and the second tab ramp close to the second disk surface 120-2 and installing a head stack assembly 50 including the first head gimbal assembly 60-1 near the first disk surface 120-1 and further including the second head gimbal assembly 60-2 near the second disk surface 120-2 to create the CSS hard disk drive.

Manufacturing this CSS hard disk drive 10 may preferably further include assembling the disk spacer 310 between the second disk surface 120-2 and the third disk surface 120-3 by rotatably coupling a spindle motor 270 to the first disk 12-1 and the second disk 12-2 through the spindle shaft center 42, and installing a head stack assembly 50 including the third head gimbal assembly 60-3 and the fourth head gimbal assembly 60-4 between the third disk surface and the fourth disk surface 120-4 to create the CSS hard disk drive.

The CSS hard disk drive 10 may further include more than two disks and more than one disk spacer. By way of example, the invention's CSS hard disk drive may include three disks separated by two disk spacers.

The preceding embodiments provide examples of the invention and are not meant to constrain the scope of the following claims.

What is claimed is:

1. A method of operating a head gimbal assembly in a Contact Start-Stop (CSS) CSS hard disk drive, comprising the steps:
asserting a pitch actuation control signal provided to at least one electrical coupling of a pitch actuator;
said pitch actuator responding to said pitch actuation control signal by flexing the flexure finger toward the load beam to increase the pitch angle of the slider to a disk surface;
wherein said slider includes at least one Pad with Diamond Like Carbon (PDLC) on an air bearing surface for use in parking said slider on said disk surface in said CSS hard disk drive.

2. The head gimbal assembly implementing the method of claim 1, comprising:
a first coupling of said load beam to said flexure finger at flexure coupling point;
a second coupling of said load beam, said flexure finger and said slider at a dimple; and
said pitch actuator coupling to said flexure finger between said flexure coupling point and said dimple.

3. The head gimbal assembly of claim 2, wherein said flexure finger, includes:
at least one pitch actuation control signal trace for providing said pitch actuation control signal to said pitch actuator.

4. The head gimbal assembly of claim 2, wherein said pitch actuator includes an electrostatic coupling responding to said pitch actuation control signal to flex said flexure finger toward said load beam to urge said flexure finger toward said load beam.

5. The head gimbal assembly of claim 4, wherein said electrostatic coupling includes a first plate coupled to said flexure finger interacting with a second plate coupled to said load beam to attract said flexure finger to said load beam.

6. The head gimbal assembly of 5, wherein said load beam includes said second plate.

7. The head gimbal assembly of claim 5, wherein said flexure finger includes said first plate.

8. The head gimbal assembly of claim 2, wherein said pitch actuator includes a piezoelectric stack coupling to said flexure finger to urge said flexure finger toward said load beam to flex said flexure finger, when said piezoelectric stack is stimulated by said pitch actuation control signal.

9. A method of manufacturing said head gimbal assembly of claim 2, comprising a member of the group consisting of the steps:
coupling said pitch actuator and said slider to said flexure finger included in a head suspension assembly to create said head gimbal assembly; wherein said head suspension assembly further includes said flexure finger coupled at said flexure coupling point to said load beam;
coupling an actuator mounted head suspension assembly to said slider to create said head gimbal assembly; wherein said actuator mounted head suspension assembly includes said pitch actuator coupled to said flexure finger included in said head suspension assembly;
coupling said pitch actuator and a loaded micro-actuator assembly to said head suspension assembly to create said head gimbal assembly; wherein said loaded micro-actuator assembly includes a micro-actuator assembly coupled to said slider; and
coupling said loaded micro-actuator assembly to said actuator mounted head suspension assembly to create said head gimbal assembly.

10. The head gimbal assembly as a product of the process of claim 9.

11. A head stack assembly for said CSS hard disk drive of claim 2, comprising:
a head stack coupling through an actuator arm to at least one of said head gimbal assemblies; and
a main flex circuit electrically coupling to said flexure finger; wherein said main flex circuit includes an embedded circuit coupling for providing said pitch actuation control signal to said pitch actuator.

12. The head stack assembly of claim 11, wherein said main flex circuit further includes a preamplifier providing said pitch actuation control signal to said pitch actuator;
wherein said preamplifier receives a pitch control signal through said embedded circuit coupling to create said pitch actuation control signal.

13. The head stack assembly of claim 12, wherein said head stack couples to at least two of said head gimbal assemblies.

14. The head stack assembly of claim 13,
wherein said main flex circuit provides
a first of said pitch actuation control signal to a first of said pitch actuator included in a first of said head gimbal assemblies, and
a second of said pitch actuation control signal to a second of said pitch actuator included in a second of said head gimbal assemblies.

15. The head stack assembly of claim 14,
wherein said preamplifier provides
said first pitch actuation control signal to said first pitch actuator and
said second pitch actuation control signal to said second pitch actuator.

16. The head stack assembly of claim 13,
wherein said main flex circuit provides said pitch actuation control signal
to a first of said pitch actuator included in a first of said head gimbal assemblies, and
to a second of said pitch actuator included in a second of said head gimbal assemblies.

17. The head stack assembly of claim 16,
wherein said preamplifier provides said pitch actuation control signal to said first pitch actuator, and to said second pitch actuator.

18. A method of manufacturing said head stack assembly of claim 11, comprising the steps:
coupling said head stack to said at least one head gimbal assembly to create a loaded head stack assembly;
electrically coupling said main flex circuit
to each of said head gimbal assemblies included in said loaded head stack assembly and
to said embedded circuit coupling to create said head stack assembly.

19. The head stack assembly as a product of the process of claim 18.

20. An embedded circuit for coupling to said head stack assembly of claim 12, including a matching coupling to said embedded circuit coupling for providing said pitch actuation control signal;
wherein said matching coupling further comprises a member of the group consisting of:
said matching coupling is presented said pitch actuation control signal by a pitch actuator driver controlled by a pitch control signal; and
said matching coupling presents said pitch control signal to said embedded circuit coupling to provide said pitch actuation control signal.

21. The embedded circuit of claim 20, further comprising:
means for receiving a humidity reading and a pressure reading creating a humidity estimate and a pressure estimate;
means for determining a pitch angle estimate based upon said humidity estimate and based upon said pressure estimate; and
means for asserting said pitch control signal when said pitch angle estimate is low.

22. The embedded circuit of claim 21,
wherein the means for receiving, further comprises:
means for receiving a temperature reading to create a temperature estimate;
wherein the means for determining said pitch angle estimate is further based upon said temperature estimate.

23. The embedded circuit of claim 21, wherein at least one member of the means group includes at least one instance of a member of the group consisting of:
a computer accessibly coupled to a memory and directed by a program system including at least one program step residing in said memory;
a finite state machine;
a neural network; and
an inferential engine;
wherein said computer includes at least one data processor and at least one instruction processor; wherein each of said data processors is at least partly directed by at least one of said instruction processors;
wherein said means group consists of: said means for receiving, said means for determining, and said means for asserting.

24. The embedded circuit of claim 21, wherein said program system, further comprises at least one member of the group consisting of the program steps:
receiving said humidity reading and said pressure reading to create said humidity estimate and said pressure estimate;
determining said pitch angle estimate based upon said humidity estimate and based upon said pressure estimate; and
asserting said pitch control signal when said pitch angle estimate is low.

25. The embedded circuit of claim 21, wherein said program system directing at least one of said instances of said computer, comprises at least one member of the group consisting of the program steps:
positioning said slider for a read-write head to follow a track on said disk surface; wherein said slider includes said read-write head;
encoding track data to create a write data stream used by said read-write head to write to said track; and
decoding a raw data received from said read-write head reading said track.

26. The embedded circuit of claim 21, further comprising: an integrated circuit, including:
means for receiving said humidity reading and said pressure reading creating said humidity estimate and said pressure estimate;
means for determining said pitch angle estimate based upon said humidity estimate and based upon said pressure estimate; and
means for asserting said pitch control signal when said pitch angle estimate is low.

27. A method of manufacturing said embedded circuit 26, comprising a member of the group consisting of the steps:
electrically coupling said matching coupling and said integrated circuit to create said embedded circuit for providing said pitch control signal through said matching coupling; and
electrically coupling said matching coupling, said pitch actuator driver, and said integrated circuit to create said embedded circuit for providing said pitch actuation control signal through said matching coupling.

28. The embedded circuit as a product of the process of claim 27.

29. The CSS hard disk drive using said embedded circuit of claim 20, comprising:
said head stack assembly electrically coupling through said embedded circuit coupling to said matching coupling of said embedded circuit; and
said head stack assembly pivotably mounted to a disk base through an actuator pivot in said head stack to position said slider included in said head gimbal assembly near said disk surface of said disk rotatably mounted on a spindle motor coupled to said disk base.

30. The CSS hard disk drive of claim 29, further comprising:
a humidity sensor and a pressure sensor located near said disk;
both of said humidity sensor and said pressure sensor communicatively couple to a means for receiving a humidity reading from said humidity sensor and a pressure reading from said pressure sensor;
wherein said embedded circuit includes said means for receiving; and
wherein said embedded circuit uses said humidity reading and said pressure reading to at least partly generate for assertion said pitch control signal.

31. The CSS hard disk drive of claim 30, further comprising:
a temperature sensor located near said disk and communicatively coupled to said means for receiving a temperature reading from said temperature sensor; and
wherein said embedded circuit further uses said temperature reading to at least partly generate for assertion said pitch control signal.

32. A method of manufacturing said CSS hard disk drive of claim 29, comprising the steps:
electrically coupling said head stack assembly through said embedded circuit coupling to said matching coupling of said embedded circuit; and
pivotably mounting said head stack assembly to said disk base through said actuator pivot to position said slider near said disk surface to create said CSS hard disk drive.

33. The CSS hard disk drive as a product of the process of claim 32.
